(19) United States
(12) Patent Application Publication
(10) Pub. No.: US 2012/0298035 A1
(43) Pub. Date: Nov. 29, 2012

(54) FLUID DISPENSING SYSTEM AND METHOD

(76) Inventor: Daniel J. MacNeil, Barrie (CA)

(21) Appl. No.: 13/462,510

(22) Filed: May 2, 2012

Related U.S. Application Data
(60) Provisional application No. 61/481,559, filed on May 2, 2011.
(60) Provisional application No. 61/481,548, filed on May 2, 2011.

(51) Int. Cl. B65D 83/00; B05C 11/00; B05C 1/00

(52) U.S. Cl. 118/696; 222/252; 222/52; 118/200

(57) ABSTRACT

A system for dispensing fluid comprises a first pumping device in communication with, and for supplying a first fluid to, a first pump outlet, a first fluid communication dispensing line for communicating the first fluid from the first pump outlet to a dispensing device, a second pumping device in communication with, and for supplying a second fluid to, a second pump outlet, and a second fluid communication dispensing line for communicating the second fluid from the second outlet to a second dispensing device. A supply sub-system causes the first pumping device to supply the first fluid to the first pump outlet and the second pumping device to supply the second fluid to the second pump outlet. The first and second pumping devices are mechanically coupled such that, when one of the pumping device supplies fluid to a pump outlet, fluid is drawn into the other pumping device through an inlet.

### CROSS-REFERENCE TO RELATED APPLICATIONS

This application claims priority from U.S. provisional application Nos. 61/481,559 and 61/481,548, both filed May 2, 2011, the contents of which are hereby incorporated herein by reference.

### FIELD OF TECHNOLOGY

The present disclosure relates to fluid dispensing systems, such as tire-shining fluid dispensing systems that may form part of vehicle washing systems.

### BACKGROUND

Vehicle wash systems may include one or more stations for shining the tires of a vehicle. Such stations typically dispense a tire-shining fluid onto an applicator, which applies the fluid to the vehicle's tires. Typically, only a relatively small volume of solution (e.g. 1.5 ounces) is applied to each tire.

Tire shining stations may be operated intermittently or infrequently, as vehicle wash systems may have periods in which they are idle, and tire shining may be an optional service for vehicle wash customers.

### SUMMARY

In one aspect of the present disclosure, there is provided a system for dispensing tire-shining fluid onto at least one tire. The system comprises: a first dispensing manifold located proximate a first location in a direction of travel of a tire through the system; a second dispensing manifold located proximate a second location downstream of the first location in a direction of travel of a tire through the system; a first pumping device in communication with, and for supplying tire-shining fluid to, the first dispensing manifold; a second pumping device in communication with, and for supplying tire-shining fluid to, the second dispensing manifold; a supply sub-system operable to cause the first pumping device to first supply tire-shining fluid to the first dispensing manifold and thereafter cause the second pumping device to supply tire-shining fluid to the second dispensing manifold.

In another aspect of the present disclosure, there is provided a method for dispensing fluid for use in cleaning and/or shining at least one tire, comprising: operating a first pumping device to supply a predetermined volume of fluid from the first pumping device to a first dispensing manifold located proximate a first location in a direction of travel of a tire; after operating the first pumping device, operating a second pumping device to supply a predetermined volume of fluid from the second pumping device to a second dispensing manifold located proximate a second location downstream of said first location in a direction of travel of a tire.

In another aspect of the present disclosure, there is provided a system for dispensing fluid, the system comprising: a first pumping device in communication with, and for supplying a first fluid to, a first fluid dispensing outlet; a second pumping device in communication with, and for supplying a second fluid to, a second fluid dispensing outlet; a supply sub-system operable to cause the first pumping device to first supply the first fluid to the first fluid dispensing outlet and thereafter cause the second pumping device to supply the second fluid to the second fluid dispensing outlet; the first and second pumping devices being mechanically coupled such that, when the first pumping device supplies the first fluid to the first fluid dispensing outlet, the second fluid is drawn into the second pumping device and when the second pumping device supplies the second fluid to the second fluid dispensing outlet, the first fluid is drawn into the first pumping device.

In another aspect of the present disclosure, there is provided a system for dispensing fluid, the system comprising: a first pumping device in communication with, and for supplying a first fluid to, an outlet; a second pumping device in communication with, and for supplying a second fluid different from the first fluid to, the outlet; a supply sub-system operable to cause the first pumping device to first supply the first fluid to the outlet and thereafter cause the second pumping device to supply the second fluid to the outlet; the first and second pumping devices being mechanically coupled such that, when the first pumping device supplies the first fluid to the outlet, the second fluid is drawn into the second pumping device and when the second pumping device supplies the second fluid to the outlet, the first fluid is drawn into the first pumping device.

In another aspect of the present disclosure, there is provided a system for dispensing fluid, the system comprising: a first pumping device in communication with, and for supplying a first fluid to, a first pump outlet; a first fluid communication dispensing line for communicating the first fluid from the first pump outlet to a first dispensing device; a second pumping device in communication with, and for supplying a second fluid to, a second pump outlet; a second fluid communication dispensing line for communicating the second fluid from the second outlet to a second dispensing device; a supply sub-system operable to cause the first pumping device to first supply the first fluid to the first pump outlet and thereafter cause the second pumping device to supply the second fluid to the second pump outlet; the first and second pumping devices being mechanically coupled and operable such that, when the first pumping device supplies the first fluid to the first pump outlet, the second fluid is drawn through the second pump inlet into the second pumping device and when the second pumping device supplies the second fluid to the second pump outlet, the first fluid can be drawn into the first pumping device.

In another aspect of the present disclosure, there is provided a system for dispensing fluid, the system comprising: a first pumping device having a pump inlet and a pump outlet, and the pumping device for supplying a first fluid supplied to the pump inlet of the first pumping device to the pump outlet of the first pumping device; a first fluid communication supply line for communicating the first fluid from a source of the first fluid to the inlet of the first pumping device; a second pumping device having a pump inlet and a pump outlet, and for supplying a second fluid supplied to the pump inlet of the second pumping device to the pump outlet of the second pumping device; a second fluid communication supply line for communicating the second fluid from a source of the second fluid to the inlet of the second pumping device; a supply sub-system operable to cause the first pumping device to first supply the first fluid to the first outlet of the first pumping device and thereafter cause the second pumping device to supply the second fluid to the outlet of the second pumping device; the first and second pumping devices being mechanically coupled and operable such that, when the first pumping device supplies the first fluid to the outlet of the first pumping device, the second fluid is drawn into the second pumping device and when the second pumping device supplies the second fluid to the outlet of the second pumping device, the first fluid is drawn into the first pumping device.

### BRIEF DESCRIPTION OF THE DRAWINGS

In the figures which illustrate by way of example only, embodiments of the present disclosure:

FIG. 1 is a schematic view of a fluid dispensing system in a first stage of operation;

FIG. 2 is a perspective view of the dual-cylinder reciprocating positive displacement pump that forms part of the system of FIG. 1;

FIG. 3 is a cross-sectional view of an anti-drip valve that forms part of the system of FIG. 1;

FIG. 4 is a perspective view of dispensing manifolds and a brush that form part of the system FIG. 1;

FIG. 5 is a schematic view of the system of FIG. 1 in a second stage of operation;

FIG. 6 is a schematic view of the system of FIG. 1 in a third stage of operation;

FIG. 7 is a schematic view of the system of FIG. 1 in a fourth stage of operation;

FIG. 8 is a schematic view of the system of FIG. 1 in a fifth stage of operation;

FIG. 9 is a schematic view of an alternate system in which fluid dispensing systems are provided on both sides of a vehicle;

FIG. 10 is a schematic view of a further alternate system;

FIG. 11 is a schematic view of a further alternate system.

### DETAILED DESCRIPTION

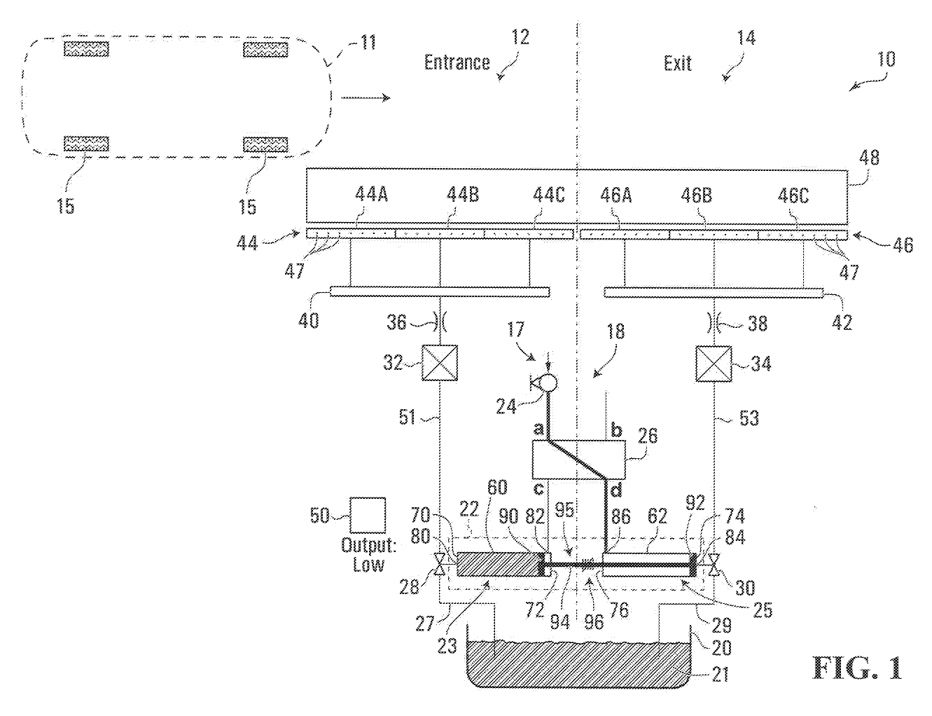

With reference to FIG. 1, an example system 10 for dispensing tire-shining fluid is schematically illustrated. The illustrated system 10 may form part of a tire-shining station of a vehicle wash system (not illustrated) wherein vehicles are conveyed or move in a tunnel, along a track or path, through various stations such as washing, rinsing and/or drying stations. Alternatively, the system 10 could be used independently of a car wash system.

The illustrated system 10 is for shining vehicle tires on one side of a vehicle 11. In some embodiments, a similar system may be situated directly opposite the system 10, leaving space sufficient for a vehicle to pass between the systems, for shining tires on the opposite side of the vehicle. That arrangement may permit tires on both the passenger side and the driver side of a vehicle to be shined simultaneously. For the sake of clarity, only one system is shown in FIG. 1 for shining tires on one side of a vehicle.

As illustrated in FIG. 1, the system 10 is generally divided into “entrance” and “exit” sections proximate to first and second locations 12 and 14 respectively. The terms “entrance” and “exit” relate to the direction of passage of the tire past the brush 48. As known by those of ordinary skill in the art pertaining to vehicle wash systems, the terms “entrance” and “exit” are commonly used to refer to the orientation of a tunnel through which vehicles pass as they are washed, as well as to the orientation of equipment within the tunnel. Thus a tire 15 that moves past the system 10 in the direction indicated in FIG. 1 will encounter the entrance section first and the exit section second. The exit section may accordingly be considered to be downstream of the entrance section in a direction of travel of the tire.

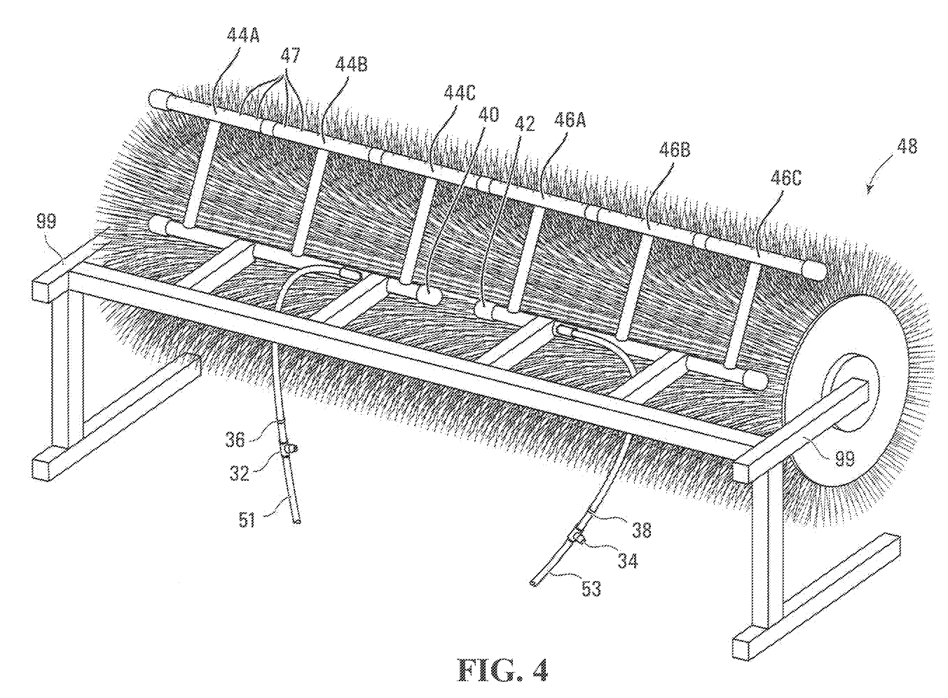

In overview, a tire-shining station may have a rotary brush 48 (or other applicator, such as a pad) at tire height, e.g. mounted on a fixed frame (e.g. frame 99 of FIG. 4), for the purpose of applying tire-shining solution to tires. The brush 48 may be of sufficient length for the rolling of the tire 15 to bring the entire outer sidewall of the tire 15 into contact with the brush 48. The brush 48 or applicator may be configured and made of a suitable material such that it can be coated with and provide for suitable distribution of a tire-shining fluid onto a tire that is in contact with the brush/applicator.

As the tire 15 enters the entrance section of the system 10, the system begins dispensing a predetermined volume of fluid onto only the entrance portion of the brush (i.e. the portion of the brush in the entrance section), at a steady rate. The dispensing is performed via a dispensing manifold 44 having a plurality of holes 47. The rotating brush 48 applies the dispensed fluid onto the tire 15 as the tire rolls past the brush, such that dispensing in the entrance section has been completed or substantially completed by the time the tire leaves the entrance section. When the tire transitions the boundary between the entrance section and the exit section, the system 10 commences dispensing fluid in the exit section, through a different dispensing manifold 46. The brush applies the dispensed fluid to the tire 15 such that, by the time that tire 15 leaves the exit section of system 10, all of or substantially all of its sidewall has been shined.

The system 10 may use a dual cylinder reciprocating positive displacement pump 22 for sequentially supplying fluid to the entrance section and then to the exit section. More specifically, a first cylinder of the pump 22 may supply fluid to the exit section of system 10 and a second cylinder may supply fluid to the entrance section of system 10. By virtue of the reciprocating motion of the pump 22, when one cylinder is supplying fluid to its associated section, the other cylinder is being refilled with fluid in preparation for the arrival of the next tire 15 to its section.

Referring again to FIG. 1, it can be seen that the example system 10 may comprise various interconnected components including a fluid reservoir 20, a dual cylinder reciprocating positive displacement pump 22, a pressure regulator 24, a four-way valve 26, check valves 28 and 30, anti-drip valves 32 and 34, flow restrictors 36 and 38, distribution manifolds 40 and 42, dispensing manifolds 44 and 46, brush 48, controller 50 and various interconnecting tubes (i.e. hoses or “lines”).

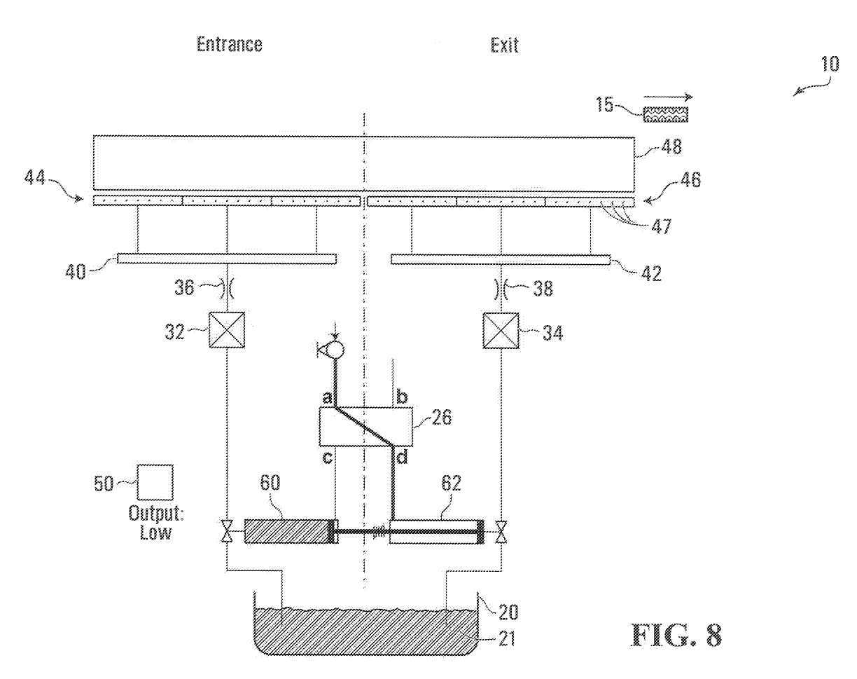

Fluid reservoir 20 may be a tank storing fluid 21 to be dispensed by the exit and entrance sections of system 10. The fluid 21, which is represented by hash marks in FIGS. 1 and 5-8, may for example a solvent-based or water-based fluid for shining or cleaning tires. The viscosity of the fluid 21 may vary depending upon whether the fluid is solvent-based or water-based, with the former possibly being more viscous than the latter.

As shown in FIG. 1, a dual-cylinder reciprocating positive displacement pump 22 can draw fluid from the reservoir 20 through tubes 27 and 29 and sequentially supplies the fluid to the entrance and exit sections for dispensing. The term “positive displacement pump” as used herein refers to any pump that causes fluid to move by trapping a predetermined volume of the fluid and then displacing that trapped volume. The example pump 22 may be constructed from two single-cylinder reciprocating positive displacement pumps 23 and 25 arranged end to end, i.e. facing in opposite directions. The first pump 23 is for supplying the entrance section of system 10 with fluid and may thus be referred to as the entrance-side pump 23. Similarly, the second pump 25 is for supplying the exit section of system 10 with fluid and may thus be referred to as the exit-side pump 23. Pumps 23 and 25 may be referred to as first and second pumping devices.

Each single-cylinder reciprocating positive displacement pump 23, 25 may have a closed cylinder 60, 62 and a piston 90, 92 that slides within the cylinder. The first cylinder 60 may be referred to herein as the entrance-side cylinder 60 and the second cylinder 62 may be referred to herein as the exit-side cylinder 62. The pistons 90, 92 sequentially draw in and displace fluid into and out of fluid ports 80, 84 in the entrance and exit-side cylinders 60 and 62, respectively. In some embodiments, cylinders 60 and 62 may be of substantially the same size and configuration, thus enabling the pistons to move in the same manner in each cylinder and thus may each discharge the same amount of tire-shining fluid. In one example embodiment, each cylinder 60, 62 may for example be a Double Acting Air Cylinder having a 1½″ diameter×2″ size, as supplied by Cowper Inc, part number D-97475-A2.

The pumps 23 and 25 are interconnected by way of a common piston arm 94 which mechanically interconnects the pistons 90 and 92. The arm 94 maintains the pistons 90 and 92 at a fixed distance from one another and has opposed end portions that are slidably received within apertures in inner end walls 72 and 76 of entrance-side cylinder 60 and exit-side cylinder 62 respectively. The first piston 90, second piston 92 and piston arm 94 thus form a unit, referred to herein as a piston assembly 95, that is free to slide longitudinally, in a reciprocating motion, within and between the cylinders 60 and 62, as described below.

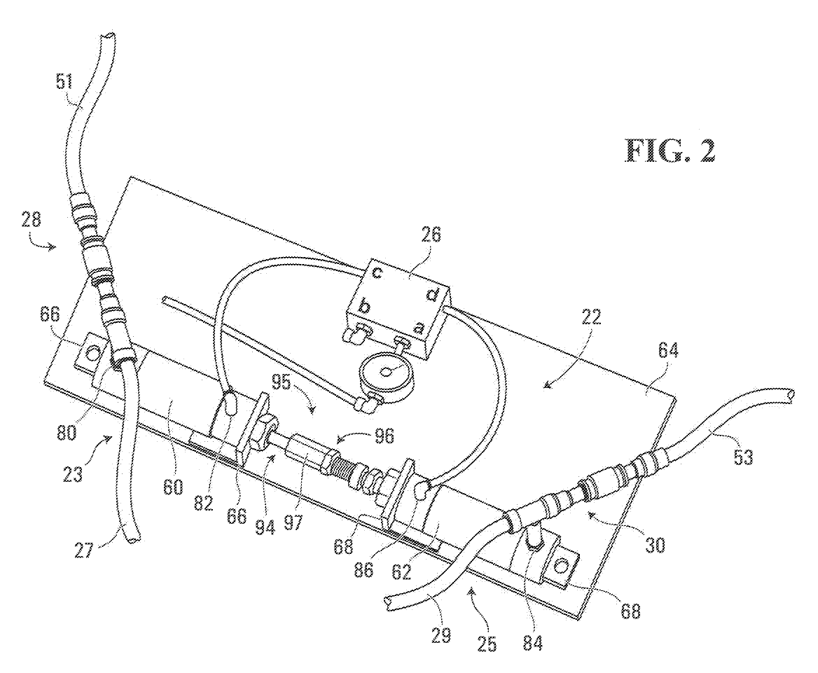

FIG. 2 illustrates the dual-cylinder reciprocating positive displacement pump 22 of FIG. 1 in perspective view. As illustrated, the entrance-side cylinder 60 and exit-side cylinder 62 are mounted onto a base 64 in fixed relation to one another in substantially longitudinal alignment. The mounting of cylinders 60, 62 to the base 64 is by way of brackets 66, 68 respectively, although mounting could alternatively be achieved using any other suitable attachment hardware.

The piston arm 94 may include an adjustable coupling 96 which permits the length of the piston arm 94 to be adjusted. In the illustrated embodiment, the adjustable coupling 96 may comprise a threaded nut 97 joining two threaded ends (not visible) of two rods that collectively make up the piston arm 94. The coupling 96 of the illustrated embodiment is arranged such that, when the nut 97 is turned, the length of the piston arm 94 increases or decreases depending upon the direction of turning. This correspondingly increases or decreases the distance between pistons 90 and 92 (see FIG. 2). Other types of mechanisms for adjusting the length of piston arm 94 could be used in alternative embodiments. As will be appreciated, lengthening or shortening the piston arm 94 decreases or increases (respectively) the distance that the piston assembly 95 is free to travel within the overall range of travel defined by the outer end walls 70 and 74 entrance and exit-side cylinder s 60 and 62, which limit the travel of pistons 90 or 92 respectively. The length of piston assembly 95 thus determines the volume of fluid that will be drawn into either the entrance-side cylinder 60 or the exit-side cylinder 62 (the volume being identical for both cylinders 60 and 62 in the illustrated embodiment). Therefore, the volume of fluid that shall be supplied to the exit section by pump 23, and the volume of fluid that shall be supplied to the entrance section by pump 25, can be increased or decreased as necessary by adjusting the coupling 96. Furthermore, because the adjustable coupling 96 is external to pumps 23 and 25 throughout the range of motion of the piston assembly 95 in the illustrated embodiment (although not necessarily in all embodiments), the adjustment may be conveniently performed, e.g. without disassembly of the system 10.

As shown in FIGS. 1 and 2, each cylinder 60, 62 has a fluid port 80, 84 in its outer end wall 70, 74 respectively. Each fluid port both receives and ejects fluid into or out of its respective cylinder. Each cylinder 60, 62 also has a gas port 82, 86 proximate to its innermost end wall 72, 76 respectively. Each gas port 82, 86 is for both receiving and exhausting compressed air into a gas chamber within the respective cylinder 60, 62 (between piston 90 and inner end wall 72 and between piston 92 and inner end wall 76). The compressed air is used to drive the piston assembly 95 in a reciprocating motion, causing each of the pistons 90, 92 to draw in and displace a predetermined volume of fluid for dispensing by the exit and entrance sections of system 10, as described below. In some embodiments, the compressed air may be replaced with another fluid such as another gas or a liquid for driving the piston assembly 95 as described herein.

Pressure regulator 24 receives compressed air from a compressed air supply 17 (indicated by a downwardly pointing arrow in FIG. 1) and regulates the pressure to a desired level based on operator input. Generally speaking, the higher the pressure, the faster the movement of the piston assembly 95 and, in turn, the faster the displacement of fluid by the pump 22. Pressure regulator 24 thus allows the rate of fluid dispensing by the system 10 to be controlled or adjusted. Pressure regulator 24 may for example be a commercially available product, such as a ¼ inch model manufactured by Watts Fluid Air, range 0-120 psi.

Four-way valve 26 may be a gas valve used to selectively connect the output of the pressure regulator 24 to one of gas ports 82 and 86, in an alternating fashion. The four-way valve 26 also selectively connects the other of gas ports 82 and 86 (i.e. whichever gas port is not connected to pressure regulator 24) to ambient pressure, so that air in cylinder 60 or cylinder 62 may be vented to the atmosphere. Control of the four-way valve 26 is by way of a control signal (e.g. an electronic signal) generated by a controller 50, described below. As will be appreciated, it is this control signal which controls the reciprocating motion cycle of the piston assembly 95. Four-way valve 26 may for example be a commercially available air solenoid valve, such as a Burkert model ¼ inch 4 way air solenoid. The four-way valve 26, in combination with the pressure regulator 24, compressed air supply 17 and associated connecting tubes, may be referred to herein as a supply sub-system 18.

Check-valves 28 and 30 may be provided to regulate the flow of tire-shining fluid into and out of cylinders 60 and 62 respectively depending upon whether the pressure in the cylinders is negative or positive in relation to the pressure in the surrounding fluid tubes. If the pressure within the cylinder 60, 62 is negative (e.g. when the piston 90, 92 is drawing fluid in through the fluid port 80, 84 respectively), the check-valve 28 or 30 prevents upstream fluid from flowing through tube 51, 53 into the cylinder 60, 62 respectively. Conversely, if the pressure within the cylinder 60, 62 is positive (e.g. when the piston 90, 92 is displacing fluid out through the fluid port 80, 84 respectively), the check-valve 28, allows fluid displaced from the cylinder to flow downstream through tube 51, 53 towards anti-drip valve 32, 34 respectively. Example check valves 28 and 30 are illustrated in perspective view in FIG. 2. Check valves 28, 30 may for example be a commercially available product, such as inline check valves manufactured by John Guest Limited. Additional check valves (not shown) disposed in tubes 27, 29 between fluid ports 80, 84 and reservoir 20, respectively, allow fluid to flow downstream from reservoir 20 into cylinders 60, 62 respectively, but prevent fluid from flowing upstream towards fluid reservoir 20. More generally, although each cylinder will have some form of associated inlet and outlet check valves in order to function as a pump, the nature and location of these is not especially critical.

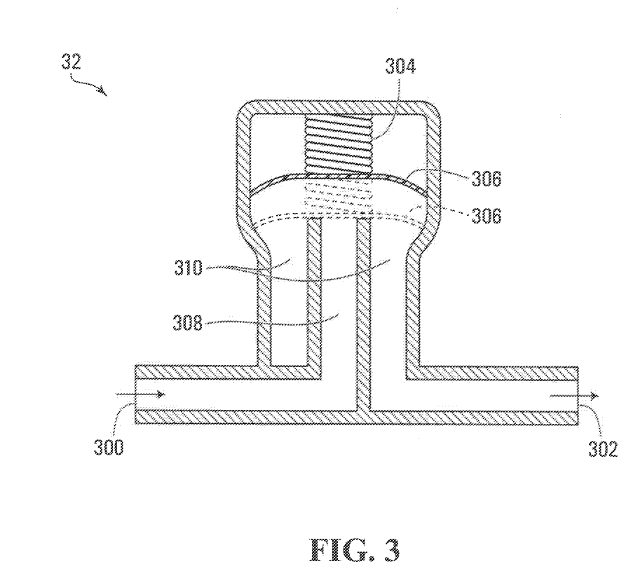

Anti-drip valves 32 and 34 may be provided and are intended to prevent tire shining fluid from dripping out of the dispensing manifolds 44 and 46 when the system 10 is idle, i.e. not actively dispensing fluid. An example anti-drip valve 32 is shown in cross-section in FIG. 3 and in perspective view in FIG. 4. Anti-drip valve 34 is similar in structure, as also shown in FIG. 4.

Referring to FIG. 3, it can be seen that anti-drip valve 32 has an inlet 300, an outlet 302, a spring 304, a circular diaphragm 306, a central ingress channel 308 and an annular egress channel 310. Briefly, the valve 32 operates as follows. In the absence of at least a threshold fluid pressure at the inlet 300, the biasing force of spring 304 presses downwardly onto diaphragm 306, causing the diaphragm 306 to seal the channels 308 and 310 as shown in dotted outline in FIG. 3. That state represents the default, closed state of the valve, wherein fluid egress from the outlet 302 is precluded or minimal.

When the fluid pressure at the inlet 300 exceeds the threshold fluid pressure, the biasing force of the spring 304 is overcome and the diaphragm 306 moves upwardly, thereby breaking the seal. This represents the open state of the valve 32, which is shown in solid lines in FIG. 3. Once the valve is 32 open, the upwardly flowing fluid emerging from central ingress channel 308 exerts force not only upon the central portion of the diaphragm 306 that is directly over the ingress channel 308, but upon substantially the entire underside of the diaphragm 306. This surface area is larger than the relatively small surface area directly over the central channel 308 upon which fluid in channel 308 was initially required to exert force in order to overcome the bias of spring 304. As a result, once the anti-drip valve 32 has opened, it tends to remain open even when the fluid pressure at the inlet 300 dips below the threshold fluid pressure. It is only when the pressure at the inlet 300 drops below a second threshold pressure, which is lower than the first threshold fluid pressure, that the valve 32 returns to its closed state. The valve accordingly exhibits hysteresis in terms of the pressure required to open versus close the valve. In one embodiment, the anti-drip valve may for example be a ½″ ANTI-DRIP NOZZLE BODY as supplied by McPhee Enterprises, Part No. 402745.

Referring to FIGS. 1 and 4, flow restrictors 36 and 38 are rigid annular rings or similar physical articles that are in fluid communication with, and downstream of, the outlets of anti-drip valves 32 and 34, respectively. Each of flow restrictors 36, 38 has an orifice that is narrower than the tube or conduit within which the flow restrictor is used. The size of the orifices of the flow restrictors 36, 38 is typically identical, although this is not absolutely required. The orifices may be referred to as “rate control orifices.”

The flow restrictors 36, 38 are intended to restrict the flow of the fluid exiting the corresponding anti-drip valve 32, 34 thereby providing a backpressure at the outlet of the upstream anti-drip valve which is substantially consistent as fluid is being dispensed. The substantial consistency of the back pressure is due to the fact that the orifice size of the flow restrictors does not substantially change over time. The reason is that, because the flow restrictors 36, 38 are mounted in-line between the anti-drip valves 32, 34 and the dispensing manifolds 44 and 46, they remain immersed in, or in contact with, fluid even when the system 10 is inactive. Thus there is little or no tendency for any fluid to dry or build up on the flow restrictors 36 or 38, which might otherwise limit the orifice size and affect the backpressure at the outlet of the anti-drip valve.

It is noted that this consistent orifice size is not necessarily seen in dispensing manifolds 44 and 46 (described below), whose holes 47 may change in size over time due to the buildup or removal of fluid that has been exposed to air and has dried. The inventor has observed that the dispensing manifold may not provide a consistent backpressure to upstream components in and of itself as a result. In some embodiments, the flow restrictor may be selected so as to be more restrictive of flow than the remainder of the downstream portion of the system 10, including the dispensing manifold, in order to be able to provide consistent backpressure. In some embodiments, the installed length of tubes 51 and 53 may be lengthy, perhaps up to one hundred feet, in which case a primary restriction may be these hoses themselves. Having a selectable orifice allows the system to be adapted to these situations. Flow restrictors 36 and 38 may for example be modular (e.g. threaded or snap-in) components that may be attached in-line with a tube as shown in FIG. 4. This may facilitate changing flow restrictors 36, 38, so as to adjust system 10 for consistent fluid flow rate despite use of a new fluid with a different viscosity from a previously used fluid. The orifice size range may be from 0.010 to 0080 inches in some embodiments. Generally, more viscous fluid warrants flow restrictors having larger orifice sizes.

Distribution manifold 40 may be a manifold having a single fluid inlet downstream of flow restrictor 36 and three outlets for supplying fluid to dispensing manifolds 44a, 44b and 44c, respectively. Distribution manifold 42 may have a similar construction. The distribution manifolds 40, 42 may help to provide a more even distribution of flow to all holes 47. Although the distribution manifolds 40, 42 are not necessarily required in all embodiments, without such manifolds there is some risk that the those holes 47 furthest from the fluid supply dispense less fluid than those nearer the supply.

Dispensing manifolds 44, 46 may be manifolds having a plurality of holes 47, which are typically evenly spaced (although not necessarily so), for dispensing tire-shining fluid onto a brush 48. The first dispensing manifold 44 may be used to dispense tire-shining fluid to the entrance section of the brush 48, while the second dispensing manifold 46 may be used to dispense fluid to the exit section of the brush 48. In the present embodiment, the dispensing manifolds are elongate and have the appearance of pipes. The dispensing manifolds of other embodiments may have other shapes.

In the present embodiment, each dispensing manifold 44, 46 may be separated into three sections. The entrance manifold 44 may have three sections 44a, 44b, 44c, and the exit manifold 46 may have three sections 46a, 46b, 46c. Each manifold section may have an inlet that is fluidly interconnected with one of the outlets of the upstream distribution manifold and a plurality of holes for dispensing tire-shining fluid. The three sections of each manifold may be arranged end to end and are rigidly interconnected in the present embodiment. The use of multiple sections in the dispensing manifolds may help to promote even distribution of dispensed tire-shining fluid across the length of brush 48, which brush may be approximately eight feet long in some embodiments. The number of dispensing manifold sections may vary in different embodiments. Multiple dispensing manifold sections may not be required or desirable in all embodiments.

As illustrated in FIG. 4, conduits between the distribution manifolds 40, 42 and the associated dispensing manifolds 44, 46 may take the form of pipes (e.g. PVC tubing) which are sufficiently rigid support the dispensing manifolds over the brush 48. Further, the two dispensing manifolds 44 and 46 may be physically interconnected as shown in FIG. 4, but are not necessarily so interconnected. Physical interconnection may reduce the likelihood that the two manifolds 44, 46 will become separated or misaligned over time, although it may complicate repair or replacement of just one of the two manifolds 44, 46. In one example embodiment, the size of the holes in the dispensing manifolds 44, 46 is 0.029″ and the number of holes is across the length of the manifolds 44 and 46 is 40. These parameters may vary in alternative embodiments.

It will be appreciated that the tubes 51 and 53 for carrying fluid form pumps 23 and 25 respectively, which tubes are illustrated in FIG. 4 as being physically lower than the holes 47 of the dispensing manifolds 44, 46, may in some installations be suspended from above such that the anti-drip valves 32, 24 and flow restrictors 36, 38 are physically higher than the holes 47. For example, the dispensing manifolds 44, 46 may be located a mere 8 inches above the floor in order for the brush 48 to contact the lower portion of the tire sidewall. In such installations, anti-drip valves 32, 24 may be particularly beneficial for the purpose of avoiding or limiting fluid loss due to dripping from the dispensing manifolds 44, 46 when the system 10 is idle.

Controller 50 is a controller that receives conventional input regarding tire position and, in response to that input, generates a control signal for causing entrance section or the exit section of the system 10 to dispense tire-shining fluid. In an embodiment wherein the fluid-dispensing system 10 forms part of a vehicle wash system, controller 50 may be, for example, the master controller used to control the vehicle wash system. The fact that the master controller may serve as the controller for the fluid-dispensing system 10 in such embodiments may avoid the need for two controllers—a master controller for the vehicle wash system plus a dedicated controller for the fluid dispensing system 10. The control signal generated by controller 50 is communicated to the four-way valve 26, which is used to control the reciprocating motion of the dual-cylinder reciprocating positive displacement pump 22. In some embodiments, the controller 50 may be Kesseltronics model RTC40.

Operation of the system 10 for dispensing tire-shining solution during the shining of a tire 15 is illustrated in FIGS. 1 and 5-8, which represent five stages of operation in the shining of the tire 15.

The first stage of operation is illustrated in FIG. 1. This stage shows the system 10 in a default or idle state, before any tire 15 has been detected as approaching the entrance section, when no fluid is being dispensed. In the default state, the piston assembly 95 of the dual-cylinder reciprocating positive displacement pump 22 is not in motion, and thus no tire-shining fluid flowing to either of the exit or entrance sections of the system 10. The controller 50 maintains a logic level “low” control signal to causes the four-way valve 26 to connect port “a” to port “d” and port “b” to port “c” (in the FIGS. 1 and 5-8, pressurized gas connections are shown in bold lines whereas unpressurized or ambient gas connections are shown in standard thickness lines). Accordingly, as illustrated, compressed air is communicated from pressure regulator 24 to gas port 86. The positive pressure has pushed the piston 92 to the limit of its range of travel, in which the piston 92 abuts the outer end wall 74 of exit-side cylinder 62. In turn, a predetermined volume of fluid (e.g. 1.5 ounces), ready for dispensing by the entrance section of system 10, has been drawn from reservoir 20 into the entrance-side cylinder 60 by the interconnected piston 90. Further, anti-drip valves 32, 24 are both in their default closed states, in which they serve to eliminate or minimize seepage of fluid from the holes 47 of dispensing manifolds 44, 46.

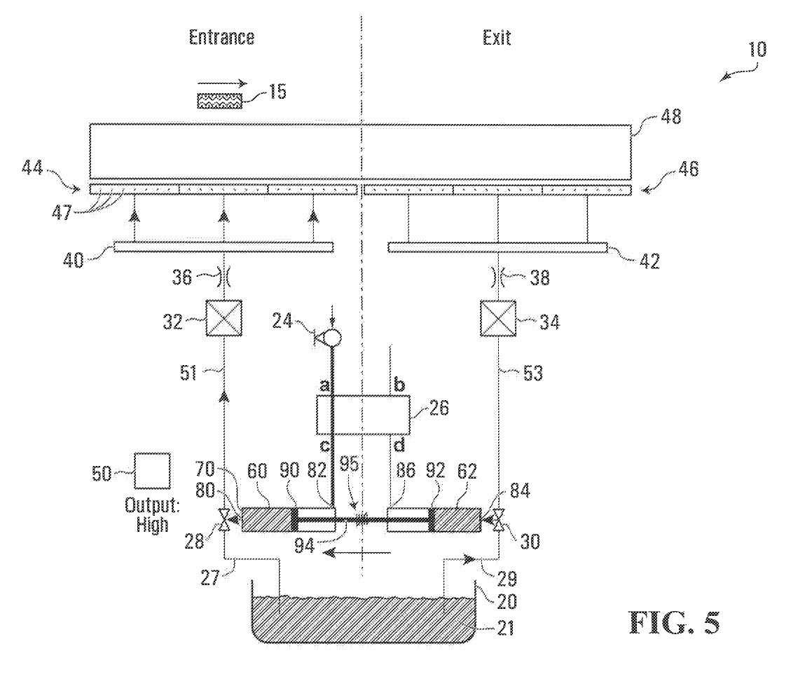

The second stage of operation is illustrated in FIG. 5. In this stage, a tire 15 to be shined has either just approached or is fully within the entrance section of the system 10. It is presumed that the position of tire 15 has been detected in a conventional manner and that the brush 48 is rotating. In response to the detection of the position of tire 15 at the entrance section of system 10, the controller 50 changes its control signal from logic level low to logic level high. The high control signal causes the four-way valve 26 to change its gas port interconnections so that the compressed air from pressure regulator 24 is communicated to port “c” (i.e. to the entrance-side cylinder 60) rather than to port “d” (i.e. to the exit-side cylinder 62). As well, the same high control signal causes the four-way valve 26 to interconnect port “b” (atmosphere) to port “d”, so that any compressed air in the exit-side cylinder 62 can be vented to the atmosphere.

As compressed air builds within the entrance-side cylinder 60, the positive pressure within the cylinder causes piston 90 to begin sliding towards the outer end wall 70 (to the left in FIG. 5). This motion initiates displacement of the predetermined volume of fluid 21 that is contained in the entrance-side cylinder 60 (see FIG. 1) out through fluid port 80. The displaced fluid exits the fluid port 80 and, by operation of a check valve (not shown) disposed between the fluid port 84 and the end of tube 27 which is submerged in fluid reservoir 20, flows downstream into tube 51 rather than upstream into tube 27 towards fluid reservoir 20. The direction of fluid flow is illustrated by arrows in FIG. 5.

The increase in fluid pressure in tube 51 opens anti-drip valve 32, permitting fluid to flow through the flow restrictor 36 into distribution manifold 40 and dispensing manifold 44. The fluid ultimately exits the holes 47 and drips onto brush 48 for application to tire 15.

As noted above, the flow restrictor 36 results in a substantially consistent backpressure at the outlet of anti-drip valve 32, which backpressure tends to consistently maintain the valve 32 in the open state even if the holes 47 of dispensing manifold 44 have narrowed or widened due to the buildup or removal of dried fluid. The flow restrictor 36 may thus promote a steady rate of fluid flow regardless of the precise condition of the dispensing holes 47, which may in turn promote a uniform distribution of fluid and, as such, uniform shining of the tire 15.

Meanwhile, by virtue of the interconnection of piston 92 to piston 90 by piston arm 94, piston 92 slides within the exit-side cylinder 62 in the same direction as piston 90. Because the exit-side cylinder 62 faces in the opposite direction, this motion of piston 92 creates a negative pressure within the fluid-containing portion of the exit-side cylinder 62. The negative pressure draws fluid 21 into the exit-side cylinder 62 through fluid port 84. By operation of check valve 30, fluid is drawn from upstream fluid reservoir 20 rather than being drawn from downstream tube 53, as illustrated by the arrows in FIG. 5. In this manner, the exit-side cylinder 62 is refilled with fluid at the same time that the entrance-side cylinder 60 is being emptied of fluid. No fluid is dispensed through the exit dispensing manifold 46. This may conserve fluid, which might otherwise be flung or drip from the brush 48 prior to the arrival of tire 15.

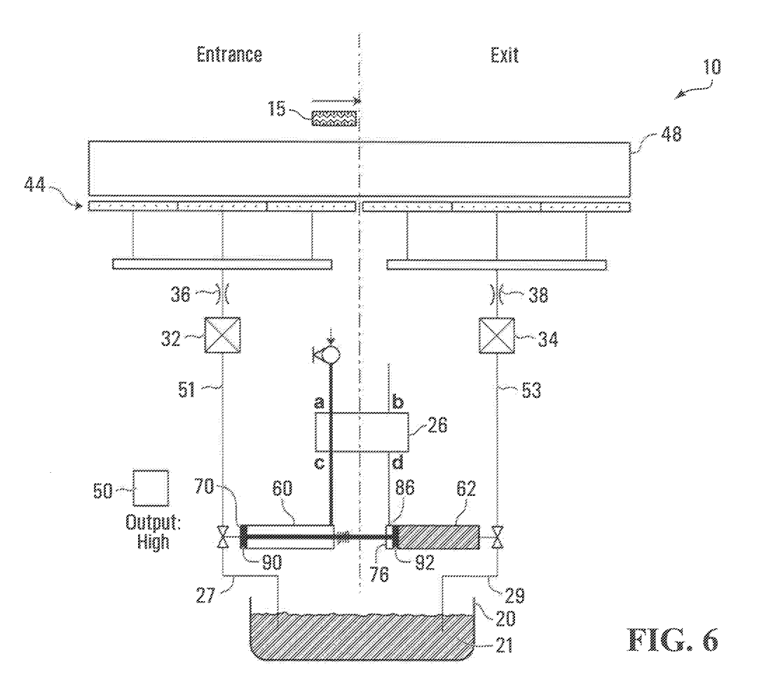

The third stage of operation is illustrated in FIG. 6. In this stage, the tire 15 is on the verge of exiting the entrance section of system 10 and is about to enter the exit section of the system. It will be appreciated that the leading edge of the tire 15 enters the exit section of the system 10 before the trailing edge of the tire 15 exits the entrance section. Prior to the trailing edge of the tire 15 exiting the entrance section, the piston 90 reaches the outer end wall 70 of the entrance-side cylinder 60, i.e. the piston assembly 95 reaches its limit of travel. As a result, the entrance-side cylinder 62 is substantially emptied of fluid, and the entrance section of the system 10 has ceased dispensing fluid. By virtue of the drop in fluid pressure at its inlet 300, the anti-drip valve 32 returns to its default closed state. For a short period of time (e.g. 2 to 10 seconds), a portion of the tire 15 remains in the entrance section of system 10 while no fluid flows through tube 51. Some residual, previously ejected fluid may continue to drip from the underside of the dispensing manifold 44 by operation of gravity onto the brush 48, which continues to rotate, applying any residual fluid to the tire 15 until the tire 15 has completely exited the entrance section. This approach may serve to conserve tire-shining fluid 21. It is noted that the termination of dispensing of tire-shining fluid by the entrance section results from the piston 90 reaching its limit of travel and thus is not directly dependent on any control signal.

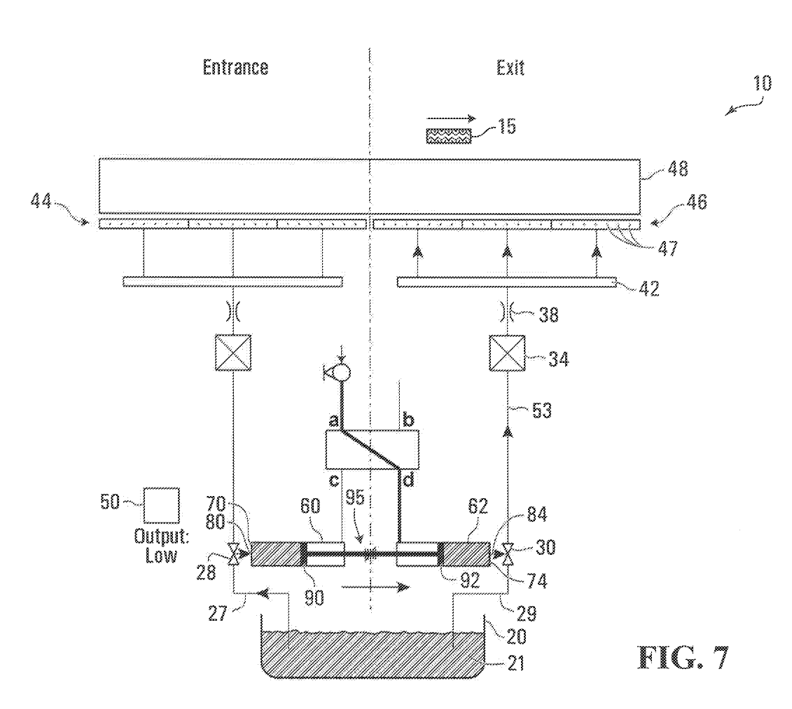

The fourth stage of operation is illustrated in FIG. 7. This stage of operation is essentially the converse of the second stage of operation illustrated in FIG. 5, with the exit-side cylinder 62 dispensing fluid while the entrance-side cylinder 60 refills with fluid instead of the opposite.

In particular, when the tire 15 enters the exit section, the controller 50 changes its control signal from high to low. The low control signal causes the four-way valve 26 to revert its original state of FIG. 1, such that compressed air is communicated from pressure regulator 24 to the exit-side cylinder 62 via port “d,” and the gas in the entrance-side cylinder 60 being vented to the atmosphere.

As compressed air builds within the exit-side cylinder 62, the positive pressure within the cylinder causes piston 92 to slide towards the outer end wall 74 (to the right in FIG. 7). This motion initiates displacement of the predetermined volume of fluid that had been contained in the exit-side cylinder 62 (see FIG. 6) from the cylinder. The displaced fluid exits the cylinder 60 through the fluid port 84 and, by operation of a check valve (not shown) disposed between the fluid port 84 and the end of tube 29 which is submerged in fluid reservoir 20, flows downstream into tube 53 rather than upstream into tube 29 towards fluid reservoir 20, as illustrated by arrows in FIG. 7. The increase in fluid pressure in tube 53 opens anti-drip valve 34, permitting fluid to flow through the flow restrictor 38 into distribution manifold 42, dispensing manifold 46. The fluid is ultimately dispensed through holes 47 for application to tire 15 by the rotating brush 48.

Meanwhile, by virtue of the interconnection of piston 90 to piston 92 by piston arm 94, piston 90 slides within the entrance-side cylinder 60, creating a negative pressure within the fluid-containing portion of the entrance-side cylinder 60. The negative pressure draws fluid 21 into the entrance-side cylinder 60 through fluid port 80. By operation of check valve 28, fluid is drawn from upstream fluid reservoir 20 through tube 27 rather than being drawn from downstream tube 53, as illustrated by the arrows in FIG. 7. In this manner, the entrance-side cylinder 60 is refilled with fluid simultaneously with the emptying of fluid from the exit-side cylinder 62.

The fifth and final stage of operation is illustrated in FIG. 5. This stage occurs when tire 15 has exited the exit section of the system 10 after having been shined. Prior to or concurrent with tire 15 exiting the exit section of the system 10, piston 92 reaches its limit of travel, terminating the dispensing of fluid by the exit section. This stage represents the default state of the system 10 and is identical to the first stage illustrated in FIG. 1. The rotation of the brush 48 may continue after the dispensing of fluid by the exit section has terminated, and may cease when tire 15 has exited the exit section of the system 10. As will be appreciated, after having shined a tire 15 as shown in FIGS. 1 and 5-7, the system 10 has returned to the same default state in which it began, and is thus prepared for the arrival of another tire 15.

As should now be appreciated, the amount of fluid to be dispensed by the exit and entrance sections of the system 10 is the volume displaced by one stroke of pistons 92, 90, respectively. The system 10 may allow this volume to be carefully set, e.g. using the adjustable coupling 96. Accordingly, it is not necessary use a control signal to meter the volume of fluid dispensed. This may be significantly more accurate than relying on other mechanisms, such as timed valves in pressurized fluid streams, for metering fluid.

Over time, the amount of fluid dispensed by the system 10 may be relatively consistent, even when fluid dries or is cleaned from the holes 47 of dispensing manifolds 44, 46. This is again by virtue of the use of positive displacement pumps 23, 25 for predetermining the amount of fluid dispensed in each cycle.

To the extent that it is desired to use the system 10 to dispense a more viscous fluid or a less viscous fluid that that which is currently being dispensed, some embodiments of the system 10 may be adjustable to dispense fluid at a consistent rate, in two ways. Firstly, the pressure regulator 24 may be used to adjust the rate of fluid dispensing. For example, the pressure may be increased if a more viscous fluid is to be dispensed, or conversely, the pressure may be decreased if a less viscous fluid is to be dispensed. Secondly, the flow restrictors 36, 38 may be changed to increase orifice size (for more viscous fluids) or decrease orifice size (for less viscous fluids). Orifice size may be the primary control and may be used to define a range of possible dispense rates. The gas pressure may be adjusted within that range to select or adjust the desired flow rate. The same adjustments allow the rate of fluid dispensing to be increased or decreased for a particular fluid.

In some embodiments, the use of a single control signal to control the cycle of dual-cylinder reciprocating positive displacement pump 22, by controlling the four-way valve 26, may reduce the number of signals that are required to control the fluid dispensing system 10, possibly reducing data path width. In some embodiments, the dispensing system 10 may accordingly be controlled by a one-bit data signal, appropriately cycled. This may help to render a tire-shining station that incorporates the fluid dispensing system 10 more compatible for control by certain commercially available “master” vehicle wash system controllers that are designed to activate stations of generic type using only one or two control signals. Such master controllers may for example control a station by sending it only one or two position-dependent signals, such as one signal for activating/deactivating equipment (e.g. causing equipment to extend contact the vehicle, causing a brush to rotate, or the like), and another signal for commencing flow of a fluid that is to be used by that station, be it water or a chemical. If a tire-shining fluid dispensing system were to require too many signals to operate (e.g. one signal for activating entrance section flow by way of a first valve, another signal for activating exit section flow by way of a second valve, and yet another signal for activating a pump to pressurize the fluid), then it may be more difficult for such a master vehicle wash system controller to control tire-shining station, particularly since that station may also require an equipment activation signal to activate a brush. The present embodiment may allow the tire-shining fluid dispensing system 10 to be controlled by only one signal (i.e. the signal that controls the four-way valve 26) from a master controller, leaving the remaining station-specific signal from the master controller available for brush 48 activation. Sequential tire-shining fluid dispensing in the entrance section and the exit sections of the tire-shining station (which may be helpful for avoiding fluid wastage) may be achieved using just this one signal.

Some vehicle wash systems may be operated at variable speeds. For example, during a busy day, vehicles may be caused to progress through a vehicle wash more quickly in order to increase the throughput of vehicles. In such systems, the period of time during which a tire 15 is in the entrance and exit sections of system 10 will vary. Controlling the dispensing of fluid using a single position-based signal and pumps which dispense a predetermined volume may enable the dispensing system 10 to be used with vehicle wash systems of varying speeds without adjusting the control signal. For example, in one embodiment, even if the wash system speed increases, the entrance-side fluid dispensing duration may be left to occur over the same duration as before, provided that dispensing ceases before the tire has left the entrance section. In that case, the tire may simply be physically closer to the exit section at the time that the fluid dispensing ceases by virtue of the cylinder 60 becoming empty. In such an example, the delay between termination of dispensing in the entrance section and commencement of dispensing in the exit section (the latter being based on detected tire position) will simply become slightly shorter (e.g. closer to 2 seconds rather than ten seconds). Other methods of metering and timing the dispensing of fluid, such as timed valves in pressurized fluid streams, may require adjustments to control signals, for example to change the timing and duration of valve opening.

Finally, the anti-drip valves 32, 24 may limit leakage and fluid waste when system is idle, even if fluid is supplied to dispensing manifolds 46, 46 from above the manifolds. At the same time, the steadiness of fluid flow rate is not sacrificed, because the substantially consistent backpressure afforded by flow restrictors 36, 38 tends to guard against premature disruption of fluid flow by the diaphragms of the anti-drip valves 32, 24. Although a conventional check valve could be used instead of the anti-drip valve 32 to provide protection against leakage, the check valve may undesirably interfere with the rate of fluid dispensing. A pilot valve could also be used as an alternative to an anti-drip valve, however the pilot valve would necessitate introduction of an additional control signal, which introduces complexity and possibly complicates control by the master controller described above. The anti-drip valves achieve the desired function using a spring and fluid pressure and thus do not require any additional control signal to be used.

It will be appreciated that the controller 50 could be effected in firmware or hardware, or using combination of software, firmware and/or hardware. The logic levels “low” and “high” generated by controller 50 could be reversed or different in an alternative embodiment.

It is also noted that while the foregoing description and corresponding FIGS. 5-8 show one tire 15 moving through the system, in most systems two or more tires on the same side of a vehicle will be shined as the vehicle moves past the brush (see for example FIG. 1). Thus the timing of the activation of the separate cylinders does not have to precisely coincide with any one tire on the side of a vehicle passing from the entrance-side dispensing manifold 44 to the exit-side dispensing manifold 46. However, the system 10 may be configured such that the change from dispensing from the entrance-side manifold to the exit-side manifold occurs substantially with the movement of the front tire of the vehicle. The rear tire will then be shined benefiting from fluid previously dispensed on the brush 48 for the front tire. Alternately, the overall system 10 may possibly be configured in some embodiments to cycle through dispensing fluid sequentially through entrance-side and exit-side manifolds for each of the front and rear vehicle tires. It will be appreciated that in addition to properly sequencing the pumps 23 and 25, the other components of the tire-shining station may have to appropriately configured such as the length of the rotary brush 48 and the length and positioning of the dispensing manifolds.

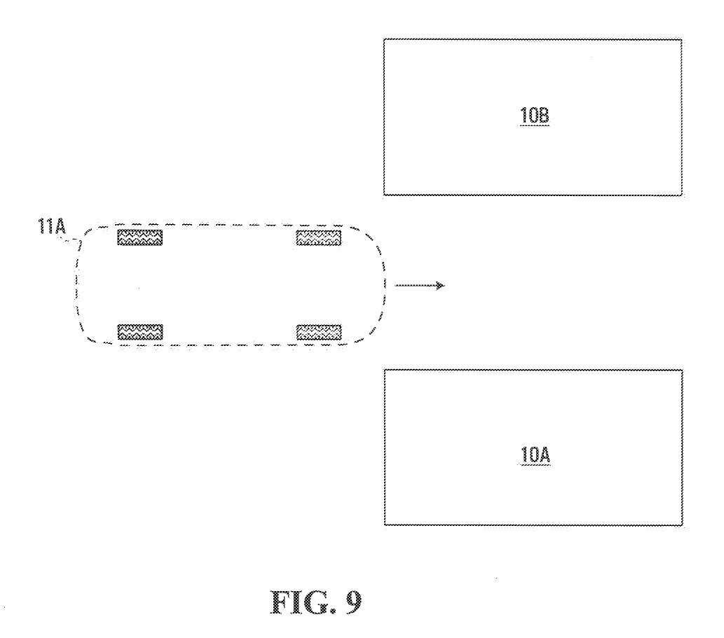

While the foregoing description shows a vehicle 11 moving past a system 10, which is on one side of the vehicle, in some embodiments, two systems may be provided to apply fluid to the tires on both sides of a vehicle. FIG. 9 shows an embodiment in which a vehicle 11a moves between two systems 10a and 10b, each of which is similar to system 10 depicted in FIGS. 1-8.

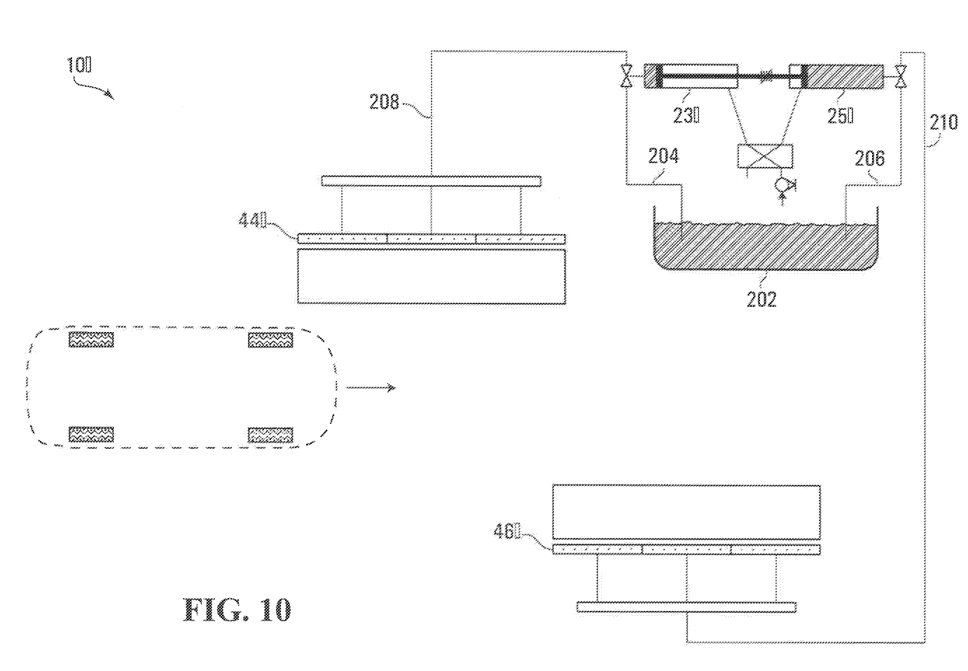

In some embodiments, pumps may supply fluid to manifolds on different sides of a vehicle. For example FIG. 10 depicts system 10′, similar to system 10. In system 10′, pump 23′ supplies fluid to manifold 44′ on a first side of a vehicle through fluid line 208 and pump 25′ supplies fluid to manifold 46′ on a second side of the vehicle through fluid line 210. Manifold 46′ is independent and physically separate from manifold 44′. Pumps 23′ and 25′ draw fluid from reservoir 202 through fluid lines 204 and 206, respectively. Alternatively, pumps 23′ and 25′ may draw fluid through fluid communication lines 204 and 206 from separate reservoirs, which may contain different fluids.

System 10′ includes valves and control components similar to those of system 10, however, for simplicity, many of these components are omitted from FIG. 10.

In the above-described embodiments, pumps 23 and 25 are used to alternately supply a fluid of one type to two different fluid-dispensing outlets, that is, manifolds 44 and 46. Alternatively, pumps 23 and 25 may supply fluid to different types of dispensing devices in a similar manner. Dispensing of fluid by pumps 23 and 25 may be continuous or may be intermittent, such that between dispensing strokes, there may be intervals of time during which pumps 23 and 25 are stationary and no fluid is dispensed.

Controller 50 generates a signal for causing one of the pumps 23 and 25 to begin dispensing fluid. Once a dispensing signal is initiated by a signal from controller 50, compressed air is supplied to one of pumps 23, 25, driving a dispensing stroke of that pump until the piston assembly 95 reaches the limit of its travel in one direction. The duration of each dispensing stroke is based on the pressure of the compressed air and is independent of the controller signals. During a dispensing stroke, a specific, predetermined volume of fluid is dispensed from pump 23 or 25, determined by the size of the respective piston and the length of its stroke.

In the above-described embodiments, system 10 is used to alternately supply fluid to two independent outlets, that is, manifolds 44 and 46. In other embodiments, a system may alternately draw fluid from two different inlets to be dispensed from a common outlet.

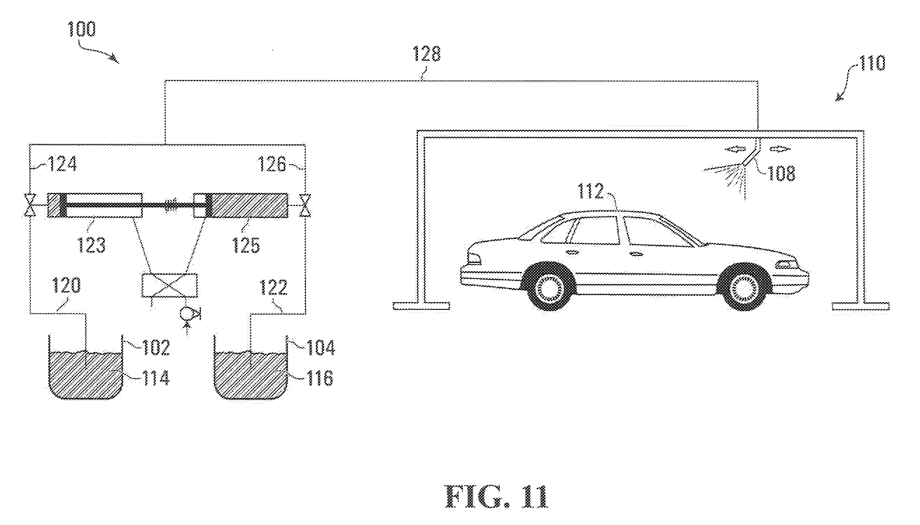

An example of such an embodiment is depicted in FIG. 11. System 100 is similar to system 10 and includes valves and control components similar to those of system 10, however, for simplicity, many of these components are omitted from FIG. 11.

System 100 includes pumps 123 and 125 like pumps 23, 25 and may be used to supply fluids to an apparatus such as gantry-type vehicle wash system 110. In a typical gantry-type system, fluid is dispensed onto a vehicle 112 through one or more fluid-dispensing outlets such as dispensing device 108. Dispensing device 108 makes a series of passes back and forth over a vehicle 112. As dispensing device 108 makes these passes, it may dispense multiple fluids onto vehicle 112.

In system 100, the inlets of pumps 123 and 125 are connected to reservoirs 102 and 104 containing fluids 114 and 116 respectively by fluid communication lines 120 and 122 respectively. Fluid 114 may be, for example, a cleaning agent, while fluid 116 may be, for example, water or a rinsing agent. During a first stroke of pumps 123 and 125, fluid 114 is dispensed by pump 123 from the outlet of pump 123 through fluid communication lines 124 and 128 to dispensing device 108. During a second stroke of pumps 123 and 125 in the opposing direction, fluid 116 is dispensed by pump 125 from the outlet of pump 125 through fluid communication lines 126 and 128 to dispensing device 108. Thus, at the beginning of a cleaning stage, a controller may generate a signal for pump 123 to begin dispensing a cleaning agent in a predetermined volume, and at some later time, the controller may generate a signal for pump 125 to begin dispensing a rinsing agent in a predetermined volume. As will be appreciated, the predetermined volume dispensed by each pump is dependent on the cross-sectional area of the piston in that pump and the length of the dispensing stroke. Thus, fluids 114, 116 may be dispensed in equal volumes, or in a fixed ratio. The latter could be effected by providing a larger piston diameter for one of the pumps 123 and 125, such that that piston displaces a larger volume in a given stroke length.

The expression “tire-shining fluid” as used herein refers to any fluid, cleaner, solution, dressing or other type of fluid for cleaning, polishing, shining or otherwise enhancing tires.

Other configurations are possible. For example, pumps 23 and 25 could be rendered mechanically independent in some embodiments. For example, the pumps might each be reloaded by another means, e.g. a spring. Dispensing of fluid by the entrance-side pump 23 may be activated by the same control signal from the master controller that activates the rotary brush, while dispensing of fluid by the exit-side pump 25 may be activated by position dependent signal from the master controller when the tire approaches the exit-side dispensing manifold 46.

In some embodiments, the signal that activates fluid dispensing at the exit-side dispensing manifold may be developed from, or based on, the brush actuation signal. For example, a simple electric or pneumatic timer may allow the system 10 to be installed even where only one station-specific position dependent control signal is available from the master controller. This may have the disadvantage however, that the timer may require readjustment if the transit speed of the vehicle past the brush is changed, so that the signal will coincide with a position of the tire proximate the second dispensing manifold 46.

In some other embodiments, the operation of the second pump to dispense fluid to the second manifold may be commenced prior to the operation first pump dispensing fluid to the first manifold having terminated.

Other modifications will be apparent to those skilled in the art and, therefore, the invention is defined in the claims.

1. A system for dispensing tire-shining fluid onto at least one tire, the system comprising:
a first dispensing manifold located proximate a first location in a direction of travel of a tire through said system;
a second dispensing manifold located proximate a second location downstream of said first location in a direction of travel of a tire through said system;
a first pumping device in communication with, and for supplying tire-shining fluid to, said first dispensing manifold;
a second pumping device in communication with, and for supplying tire-shining fluid to, said second dispensing manifold;
a supply sub-system operable to cause said first pumping device to first supply tire-shining fluid to said first dispensing manifold and thereafter cause said second pumping device to supply tire-shining fluid to said second dispensing manifold.

2. A system as claimed in claim 1 wherein said supply sub-system is operable to cause said second pumping device to supply tire-shining fluid to said second dispensing manifold only after said first pumping device has ceased supplying tire-shining fluid to said first dispensing manifold.

3. A system as claimed in claim 1 wherein each of said first and second pumping devices comprises a positive displacement pump configured to periodically displace a predetermined volume of tire-shining fluid to respectively supply said first and second dispensing manifolds.

4. A system as claimed in claim 3 wherein each of said first and second pumping devices comprises a reciprocating pump.

5. A system as claimed in claim 3 wherein each of said first and second pumping devices comprises a piston pump.

6. A system as claimed in claim 3 where said first and second pumping devices are adjustable such that said predetermined volumes of tire-shining fluid supplied to each of said first and second dispensing manifolds may be adjusted.

7. A system as claimed in claim 6 wherein said supply sub-system is operable to facilitate sequential loading of each of said first and second pumping devices with tire-shining fluid.

8. A system as claimed in claim 5 further comprising a common driven reciprocating piston arm interconnecting said first and second pumping devices, said first and second pumps and said piston arm being configured such that when said piston arm moves in a first direction to cause said first pumping device to supply tire-shining fluid to said first dispensing manifold, said second pumping device is reloaded with tire-shining fluid and wherein when said piston arm moves in a second direction opposite to said first direction to cause said second pumping device to supply tire-shining fluid to said second dispensing manifold, said first pumping device is reloaded with tire-shining fluid.

9. A system as claimed in claim 8 where the length of said piston arm of said first and second pumping devices is adjustable such that said predetermined volumes of tire-shining fluid supplied to each of said first and second dispensing manifolds may be adjusted.

10. A system as claimed in claim 3 further comprising (a) a first rate control orifice interposed in a fluid supply between said first pumping device and said first dispensing manifold and (b) a second rate control orifice interposed in a fluid supply between said second pumping device and said second dispensing manifold.

11. A system as claimed in claim 3 wherein said supply sub-system comprises a supply of a powering fluid delivered to each of said first and second pumping devices.

12. A system as claimed in claim 11 wherein supply of powering fluid is a compressed gas.

13. A system as claimed in claim 12 wherein said compressed gas is compressed air.

14. A system as claimed in claim 13 further comprising (a) a first rate control orifice interposed in a tire-shining fluid supply between said first pumping device and said first dispensing manifold and (b) a second rate control orifice interposed in a tire-shining fluid supply between said second pumping device and said second dispensing manifold.

15. A system as claimed in claim 14 wherein said supply sub-system further comprises an air pressure regulator and an air solenoid valve configured to be able to alternately supply pressurized air to said first and second pumping devices.

16. A system as claimed in claim 15 wherein said air solenoid valve is a four-way valve.

17. A system as claimed in claim 15 wherein said supply sub-system supplies pressurized air to said first pumping device responsive to a control signal having a first logic level and wherein said supply sub-system supplies pressurized air to said second pumping device responsive to said control signal having a second logic level.

18. A system as claimed in claim 17 wherein said first and second pumping devices are interconnected with and share a common driven reciprocating piston arm; said first and second pumps being configured such that when compressed air is supplied to said first pumping device, said piston arm moves in a first direction to cause said first pumping device to supply tire-shining fluid to said first dispensing manifold and said second pumping device is loaded with tire-shining fluid and wherein when compressed air is supplied to said second pumping device said piston arm moves in a second direction opposite to said first direction to cause said second pumping device to supply tire-shining fluid to said second dispensing manifold and said first pumping device is loaded with tire-shining fluid.

19. A system as claimed in claim 18 where the length of said piston arm of said first and second pumping devices is adjustable such that said predetermined volumes of tire-shining fluid supplied to each of said first and second dispensing manifolds may be adjusted.

20. A system as claimed in claim 17 wherein said supply sub-system further comprises a controller.

21. A system as claimed in claim 18 wherein said supply sub-system further comprises a controller.

22. A system as claimed in claim 3 further comprising an anti-drip valve having an inlet and an outlet, the inlet of said anti-drip valve being in fluid communication with an outlet of said positive displacement pump, said anti-drip valve initially being biased closed in the absence of at least a first threshold fluid pressure at said inlet of said anti-drip valve, said anti-drip valve being configured to subsequently remain open until the fluid pressure at said inlet of said anti-drip valve drops below a second threshold fluid pressure that is lower than said first threshold fluid pressure.

23. A system as claimed in claim 1 further comprising at least one source of tire-shining fluid and wherein said first and second pumping devices are in fluid communication with said at least one source of tire-shining fluid.

24. A method for dispensing fluid for use in cleaning and/or shining at least one tire, comprising:
(a) operating a first pumping device to supply a predetermined volume of fluid from said first pumping device to a first dispensing manifold located proximate a first location in a direction of travel of a tire;
(b) after step (a), operating a second pumping device to supply a predetermined volume of fluid from said second pumping device to a second dispensing manifold located proximate a second location downstream of said first location in a direction of travel of a tire.

25. A system for dispensing fluid, the system comprising:
a first pumping device in communication with, and for supplying a first fluid to, a first fluid dispensing outlet;
a second pumping device in communication with, and for supplying a second fluid to, a second fluid dispensing outlet;
a supply sub-system operable to cause said first pumping device to first supply said first fluid to said first fluid dispensing outlet and thereafter cause said second pumping device to supply said second fluid to said second fluid dispensing outlet;
said first and second pumping devices being mechanically coupled such that, when said first pumping device supplies said first fluid to said first fluid dispensing outlet, said second fluid is drawn into said second pumping device and when said second pumping device supplies said second fluid to said second fluid dispensing outlet, said first fluid is drawn into said first pumping device.

26. The system of claim 25, wherein said first and second fluids are the same type of fluid.

27. The system of claim 25, wherein said first and second fluids are different types of fluids.

28. The system of claim 25 wherein the supplying of said first fluid occurs during a first stroke of the first and second pumping devices and wherein the supplying of said second fluid occurs during a second, opposing stroke of the first and second pumping devices, the system further comprising a controller for controlling the supply subsystem to initiate the first and second strokes, wherein the controller signals only the beginning of the first and second strokes.

29. The system of claim 28 wherein the supply subsystem is operable to, upon receiving each of the controller signals signalling the beginning of the first and second strokes, supply a pressurized powering fluid, to one of the first and second pumping devices, for driving the first and second strokes respectively, such that a duration of each of said first and second strokes is based on a pressure of the pressurized powering fluid and is independent of the controller signals.

30. The system of claim 29 configured so that a duration between the controller signals signalling the beginning of the first and second strokes is longer than a duration of said first stroke.

31. The system of claim 28, wherein a first predetermined volume of said first fluid is displaced during said first stroke and a second predetermined volume of said second fluid different from said first predetermined volume is displaced during said second stroke.

32. A system for dispensing fluid, the system comprising:
a first pumping device in communication with, and for supplying a first fluid to, an outlet;
a second pumping device in communication with, and for supplying a second fluid different from said first fluid to, said outlet;
a supply sub-system operable to cause said first pumping device to first supply said first fluid to said outlet and thereafter cause said second pumping device to supply said second fluid to said outlet;
said first and second pumping devices being mechanically coupled such that, when said first pumping device supplies said first fluid to said outlet, said second fluid is drawn into said second pumping device and when said second pumping device supplies said second fluid to said outlet, said first fluid is drawn into said first pumping device.

33. The system of claim 32 wherein the supplying of the first fluid occurs during a first stroke of the first and second pumping devices and wherein the supplying of the second fluid occurs during a second, opposing stroke of the first and second pumping devices, the system further comprising a controller for controlling the supply subsystem to initiate the first and second strokes, wherein the controller signals only the beginning of the first and second strokes.

34. The system of claim 33 wherein the supply subsystem is operable to, upon receiving each of the controller signals signalling the beginning of the first and second strokes, supply a pressurized powering fluid, to one of the first and second pumping devices, for driving the first and second strokes respectively, such that a duration of each of said first and second strokes is based on a pressure of the pressurized powering fluid and is independent of the controller signals.

35. The system of claim 34 configured so that a duration between the controller signals signalling the beginning of the first and second strokes is longer than a duration of said first stroke.

36. The system of claim 33, wherein a first predetermined volume of said first fluid is displaced during said first stroke and a second predetermined volume of said second fluid different from said first predetermined volume is displaced during said second stroke.

37. The system of claim 32, wherein said outlet is in fluid communication with a dispensing manifold.

38. A system for dispensing fluid, the system comprising:
a first pumping device in communication with, and for supplying a first fluid to, a first pump outlet;
a first fluid communication dispensing line for communicating said first fluid from said first pump outlet to a first dispensing device;
a second pumping device in communication with, and for supplying a second fluid to, a second pump outlet;
a second fluid communication dispensing line for communicating said second fluid from said second outlet to a second dispensing device;
a supply sub-system operable to cause said first pumping device to first supply said first fluid to said first pump outlet and thereafter cause said second pumping device to supply said second fluid to said second pump outlet;
said first and second pumping devices being mechanically coupled and operable such that, when said first pumping device supplies said first fluid to said first pump outlet, said second fluid is drawn through said second pump inlet into said second pumping device and when said second pumping device supplies said second fluid to said second pump outlet, said first fluid can be drawn into said first pumping device.

39. The system of claim 38, wherein said system is operable such that said first and second fluids are different types of fluids.

40. A system for dispensing fluid, the system comprising:
a first pumping device having a pump inlet and a pump outlet, and said pumping device for supplying a first fluid supplied to said pump inlet of said first pumping device to said pump outlet of said first pumping device;
a first fluid communication supply line for communicating said first fluid from a source of said first fluid to said inlet of said first pumping device;
a second pumping device having a pump inlet and a pump outlet, and for supplying a second fluid supplied to said pump inlet of said second pumping device to said pump outlet of said second pumping device;
a second fluid communication supply line for communicating said second fluid from a source of said second fluid to said inlet of said second pumping device;
a supply sub-system operable to cause said first pumping device to first supply said first fluid to said first outlet of said first pumping device and thereafter cause said second pumping device to supply said second fluid to said outlet of said second pumping device;
said first and second pumping devices being mechanically coupled and operable such that, when said first pumping device supplies said first fluid to said outlet of said first pumping device, said second fluid is drawn into said second pumping device and when said second pumping device supplies said second fluid to said outlet of said second pumping device, said first fluid is drawn into said first pumping device.

41. The system of claim 40, wherein said system is operable such that said first and second fluids are the same type of fluid and said first and second fluids are drawn from a common source of fluid.

42. The system of claim 40, wherein said system is operable such that said first and second fluids are different types of fluids and said first and second fluids are drawn from different sources.

43. The system of claim 41, wherein said system further comprises:
a first fluid communication dispensing line for communicating said first fluid from said first pump outlet to a dispensing device;
a second fluid communication dispensing line for communicating said second fluid from said second outlet to a dispensing device.

44. The system of claim 43, wherein said system is operable such that said first and second fluids are the same type of fluid and said first and second fluids may be dispensed through respective first and second fluid communication dispensing lines to the same dispensing device.

45. The system of claim 42, wherein said system further comprises:
a first fluid communication dispensing line for communicating said first fluid from said first pump outlet to a dispensing device;
a second fluid communication dispensing line for communicating said second fluid from said second outlet to a dispensing device.

46. The system of claim 45, wherein said system is operable such that said first and second fluids are different types of fluids and said first and second fluids may be dispensed through respective first and second fluid communication dispensing lines to different dispensing devices.

47. A system for dispensing fluid, the system comprising:
a first dispensing device located proximate a first location in said system suitable for dispensing fluid on a tire;
a second dispensing device located proximate a second location in said system suitable for dispensing fluid on a tire;
a first pumping device in communication with, and for supplying fluid to, said first dispensing device;
a second pumping device in communication with, and for supplying fluid to, said second dispensing device;
a supply sub-system operable to cause said first pumping device to supply fluid to said first dispensing device and to cause said second pumping device to supply fluid to said second dispensing device.

48. The method of claim 47, wherein said first and second pumping devices are positive-displacement pumps.

49. The method of claim 48, wherein each of said first and second pumping devices is configured to periodically displace a predetermined volume of fluid to respectively supply said first and second dispensing devices.

50. The method of claim 49, wherein said second pumping device supplies fluid to said second dispensing device after said first pumping device supplies fluid to said first dispensing device.

51. The system of claim 47, wherein said fluid comprises tire-shining fluid.

52. A method for dispensing fluid for application to at least one tire, comprising:
(a) operating a first pumping device to supply a predetermined volume of fluid from said first pumping device to a first dispensing device located proximate a first location in a direction of travel of a tire;
(b) operating a second pumping device to supply a predetermined volume of fluid from said second pumping device to a second dispensing device located proximate a second location in a direction of travel of a tire.

53. The method of claim 52, wherein each of said first and second pumping devices comprises a positive displacement pump.

54. The method of claim 53, wherein said operating said second pumping device occurs after said operating said first pumping device.

55. The method of claim 52, wherein said fluid comprises a tire shining fluid.

56. A system for dispensing fluid, the system comprising:
a first dispensing device located proximate a first location in a said system suitable for dispensing fluid on a tire;
a second dispensing device located proximate a second location in said system suitable for dispensing fluid on a tire;
a pumping subsystem in communication with, and for supplying fluid to, said first and second dispensing devices;
a supply sub-system operable to cause said pumping subsystem to supply a first predetermined volume of fluid to said first dispensing device during a first stroke of said pumping device and to cause said pumping subsystem to supply a second predetermined volume of fluid to said second dispensing device during a second stroke of said pumping subsystem.

57. The system of claim 56, wherein said pumping subsystem comprises a positive displacement pump.

58. The system of claim 56, wherein said pumping subsystem comprises first and second positive displacement pumps, said first positive displacement pump operable to supply said first predetermined volume of fluid to said first dispensing device and said second positive displacement pump operable to supply said second predetermined volume of fluid to said second dispensing device.

59. The system of claim 56, wherein said supply sub-system is operable to cause said pumping subsystem to supply said second predetermined volume of fluid after said first predetermined volume of fluid is supplied.

60. The system of claim 56, wherein said fluid comprises tire shining fluid.

61. A method for dispensing fluid for application to at least one tire, comprising:
(a) operating a pumping subsystem through a first stroke to supply a first predetermined volume of fluid from said pumping subsystem to a first dispensing device located proximate a first location in a direction of travel of a tire;
(b) operating said pumping subsystem through a second stroke to supply a second predetermined volume of fluid from said pumping subsystem to a second dispensing device located proximate a second location in a direction of travel of a tire.

62. The method of claim 61, wherein said pumping subsystem comprises first and second positive displacement pumps, and said first and second strokes are strokes of said first and second positive displacement pumps, respectively.

63. The method of claim 62, wherein said operating said pumping subsystem through said second stroke occurs after operating said pumping subsystem through said first stroke.

64. The method of claim 61, wherein said fluid comprises tire-shining fluid.
